(19) United States
(12) Patent Application Publication
(10) Pub. No.: US 2021/0061468 A1
(43) Pub. Date: Mar. 4, 2021

(54) AIRCRAFT CABIN, EXTENDING INTO A FUSELAGE ALONG AN AIRCRAFT AXIS AND ASSOCIATED BUSINESS JET

(71) Applicant: DASSAULT AVIATION, PARIS (FR)

(72) Inventors: Maxime ROBERT, SAINT CLOUD (FR); Agnès GERVAIS, SAINT CLOUD (FR)

(21) Appl. No.: 17/003,675

(22) Filed: Aug. 26, 2020

(30) Foreign Application Priority Data
Aug. 26, 2019 (FR) FR 19 09398

(51) Int. Cl. B64D 11/00

(52) U.S. Cl. CPC B64D 11/00; B64D 2011/0046

(57) ABSTRACT

The cabin includes a rear compartment including at least one luggage storage area and/or a lavatory, a main compartment including a plurality of seats, and an intermediate compartment. The intermediate compartment includes, on either side of the fuselage, isolation areas, and a central passageway, having a width greater than 50.8 cm. Each isolation area includes a seat and longitudinal partitions delimiting an access opening to the isolation area. Each seat is maneuverable between a retracted seating position for an occupant of the isolation area and an extended lying position of an occupant of the isolation area.

The present disclosure relates to an aircraft cabin extending into a fuselage along an aircraft axis between a front end transverse wall intended to be adjacent to a cockpit of the aircraft and a rear end transverse wall, intended to be adjacent to a rear technical hold of the aircraft, the cabin delimiting an inner volume accessible to a passenger of the aircraft, the cabin including, in the inner volume:
a rear compartment, delimited by the rear end transverse wall and including at least one luggage storage area and/or a lavatory,
a main compartment including a plurality of seats, and
an intermediate compartment whose rear is adjacent to the rear compartment and whose front is adjacent to the main compartment;
a rear transverse wall, provided with a door, the rear transverse wall delimiting the front of the rear compartment;
an intermediate transverse wall delimiting a circulation opening between the intermediate compartment and the main compartment, the intermediate transverse wall delimiting the rear of the main compartment, the intermediate compartment extending between the rear transverse wall and the intermediate transverse wall.

### BACKGROUND

The aircraft is a business jet. A “business jet” in particular refers to an airplane having a total mass at takeoff of less than 55,000 kg (121,000 pounds). A business jet is generally certified to transport fewer than 25 passengers, in particular fewer than 21 passengers.

In business aviation, passengers wish to have significant comfort in the cabin, so that they can work and/or rest when the journey is long.

Generally, business jet cabins include at least one main compartment, in which a plurality of seats and/or tables are placed allowing the passengers to work and/or to rest in a seated position.

Business jets quite often comprise a rear compartment in which there is a luggage storage area and/or a lavatory.

For improved comfort, some business jets are further equipped with an intermediate compartment, separated from the front compartment by a transverse wall, in which there are lateral sofas facing one another. The rear compartment is further separated from the intermediate compartment by a door.

When the trip is long, this type of business jet can be laid out to allow certain passengers to sleep in the recumbent position.

In the main compartment, inflatable devices and/or mattresses are for example mounted between the seats and the tables or on the latter to provide berths in the recumbent position.

In the intermediate compartment, the lateral sofas are deployable toward the aircraft axis to transition to a bed position and provide two berths for aircraft passengers wishing to isolate themselves relative to those present in the main compartment.

However, such a layout is not fully satisfactory. Indeed, when the sofas present in the intermediate compartment have transitioned to the bed position, the passageway between the two sofas is reduced considerably, or even eliminated.

This configuration of the intermediate cabin completely prevents the occupants from moving toward the rear compartment including the luggage and/or the lavatories. The comfort of the cabin is therefore temporarily reduced as a result, as long as the passengers are sleeping in the rear.

### SUMMARY

One aim of the present disclosure is therefore to provide an aircraft cabin layout simultaneously allowing some passengers to have increased reclining comfort and/or substantial isolation, without hindering the movement of other passengers in the aircraft.

To that end, the present disclosure relates to an aircraft cabin of the aforementioned type, characterized in that the intermediate compartment includes, on either side of the fuselage, isolation areas, and between the isolation areas, a central passageway, the central passageway having a width greater than 50.8 cm, each isolation area including a seat and at least one longitudinal partition separating the isolation area from the central passageway and delimiting an access opening to the isolation area, each seat located in an isolation area being maneuverable between a retracted seating position for an occupant of the isolation area and an extended lying position of an occupant of the isolation area.

The aircraft cabin according to the present disclosure may comprise one or more of the following features, considered alone or according to any technically possible combination:
the central passageway has a width smaller than 61 cm taken transversally between the longitudinal partitions of the respective isolation areas;
the door of the rear transverse wall opens opposite the central passageway;
the width of the door of the rear transverse wall is less than 110% of the width of the central passageway;
in the extended position, each seat in an isolation area delimits a horizontal elongation surface for the occupant, having a length greater than 198 cm, and advantageously a width greater than 55.9 cm;
each area includes a front longitudinal partition and a rear longitudinal partition delimiting the access opening to the isolation area between them;
one of the front lateral partition or the rear lateral partition is longitudinally movable relative to the seat located in the isolation area;
the intermediate compartment includes at least one curtain able to close off the access opening to the isolation area;
each isolation area includes at least one table, deployable opposite the seat located in the isolation area;
the intermediate compartment includes at least one cabinet located at the front of or at the rear of an isolation area; and
it includes a total number of seats less than twenty-five between the front end transverse wall intended to be adjacent to the cockpit of the aircraft and the rear end transverse wall, intended to be adjacent to the rear technical hold of the aircraft.

A business jet is also provided including a cockpit, and an aircraft cabin as defined above, the aircraft cabin emerging at the front in the cockpit.

The business jet according to the present disclosure may include one or more of the following features, considered alone or according to any technically possible combination(s):
it has a maximum mass at takeoff of less than 55,000 kg, and
it includes, at the rear of the rear compartment, a technical hold adjacent to the rear compartment, the technical hold defining the rear end of the aircraft.

### DESCRIPTION OF THE DRAWINGS

The present disclosure will be better understood upon reading the following description, provided solely as an example, and in reference to the appended drawings, in which:

FIG. 1 is a top view of a floor plan of a first aircraft cabin according to the present disclosure, in a business jet;

FIG. 2 is a view similar to FIG. 1 of the intermediate compartment, the left seat being in the deployed position, the right seat being in the retracted position;

FIG. 3 is a perspective view of the intermediate compartment;

FIG. 4 is a side view of an isolation area including the right seat in the intermediate compartment, the seat being in the retracted position; and

FIG. 5 is a view similar to FIG. 4, the seat being in the deployed position.

### DESCRIPTION OF PREFERRED EMBODIMENTS

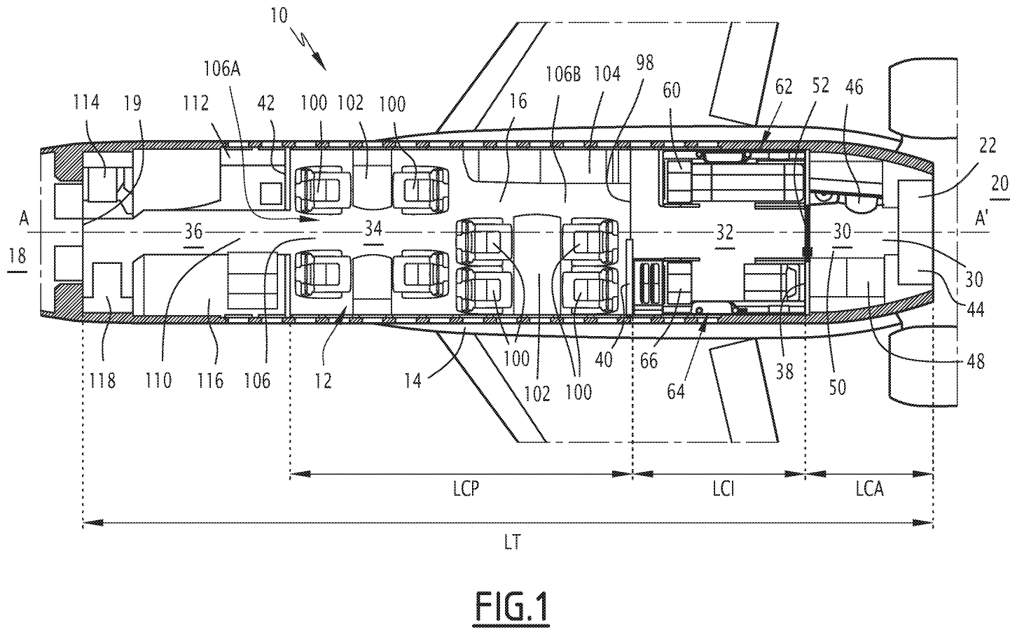

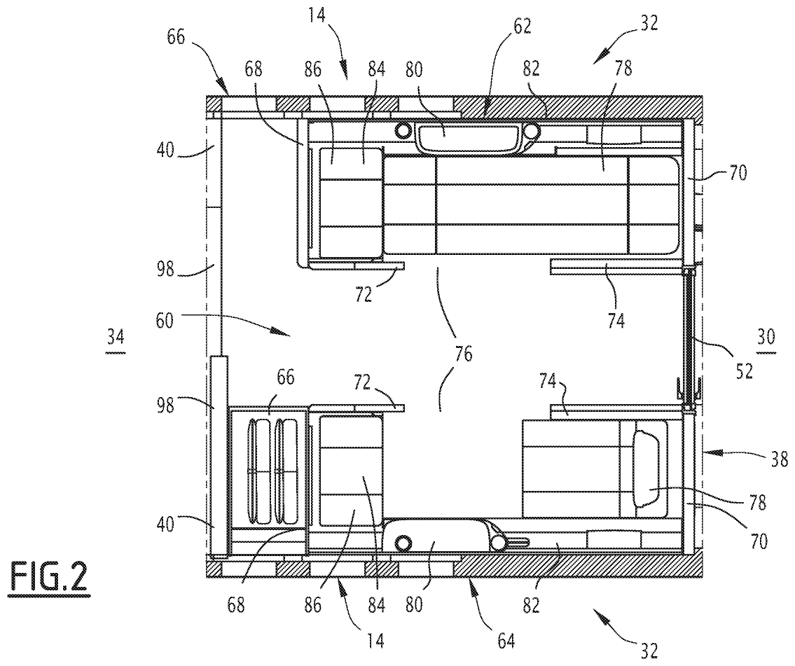

A first aircraft 10 including a cabin 12 according to the present disclosure is illustrated by FIGS. 1 to 5. The aircraft 10 is a business jet.

“Business jet” refers to an aircraft capable of transporting a maximum of twenty-five passengers, preferably a maximum of twenty-one passengers. The maximum takeoff weight (MTOW) of the business jet is preferably less than 55,000 kg (121,000 pounds).

The aircraft 10 includes, between the front end and the rear end of the aircraft 10, a fuselage 14 delimiting an inner volume 16 comprising the cockpit 18, the cabin 12, and behind the cabin 12, a technical hold 20.

The fuselage 14 preferably has a maximum outer diameter of less than 3 m (less than 10 feet).

The cockpit 18 is intended to receive the crew members. It contains the equipment necessary for the piloting and navigation of the aircraft, in particular the flight controls and the avionics making it possible to track and pilot the flight.

The cockpit 18 is separated from the cabin 12 by a cabin front end transverse wall 19, provided with an access door to the cockpit.

The technical hold 20 is arranged at the rear of the aircraft. It extends behind the cabin 12, to the rear end of the aircraft. The technical hold 20 is intended to receive equipment items necessary for the operation of the aircraft, such as computer equipment items. It is not intended to receive passengers.

The technical hold 20 is separated from the cabin 12 by a cabin rear end transverse wall 22.

The cabin 12 is a space intended to receive the passengers and the commercial crew of the aircraft. It extends along the aircraft axis A-A′ between the end transverse walls 19, 22. It includes, from rear to front, a rear compartment 30 adjacent to the technical hold 20, an intermediate compartment 32 for isolation and passenger comfort, a main compartment 34, and a service and crew rest compartment 36.

The cabin 12 further includes a rear transverse wall 38 separating the rear compartment 30 from the intermediate compartment 32, an intermediate transverse wall 40 separating the intermediate compartment 32 from the main compartment 34 and a front transverse wall 42 separating the main compartment 34 from the service and crew rest compartment 36.

The rear compartment 30 is located at the rear end of the cabin 12. It represents the rearmost space in which the passengers and the crewmembers can move in the cabin 12 in the standing position.

In this example, the rear compartment 30 includes a luggage storage area 44, a lavatory 46 and optionally a storage cabinet 48.

The luggage storage area 44 here is formed by a cabinet, located behind the rear compartment 30. The cabinet here opens axially by a door located in the aircraft axis A-A′. The luggage storage area 44 is delimited in the rear by the cabin rear end transverse wall 22.

The lavatory 46 here is located on one side of the fuselage 14. In this example, it includes a toilet and at least one sink.

The storage cabinet 48 is located on another side of the fuselage 14. In this example, the rear compartment 30 thus comprises a rear passageway 50, extending along the aircraft axis A-A′, with a width greater than 50.8 cm (greater than 20 inches) and in particular comprised between 50.8 cm and 61 cm (between 20 and 24 inches). This allows in-flight passenger access to the luggage storage area 44.

The rear compartment 30 is advantageously devoid of seats extending longitudinally.

The rear transverse wall 38 is provided with a rear door 52, for example a sliding door or a swinging door.

The rear door 52 is centered relative to the aircraft axis A-A′. When it is open, it delimits a passage opening with a width greater than 50.8 cm (greater than 20 inches) and in particular comprised between 50.8 cm and 61 cm (between 20 and 24 inches).

As indicated above, the intermediate compartment 32 is intended to form an isolation and comfort area for no more than two passengers of the aircraft 10. It extends axially between the rear transverse wall 38 and the intermediate transverse wall 40.

The length LCI of the intermediate compartment 32, projected along the aircraft axis A-A′, is greater than the length LCA of the rear compartment 30 and is less than the length LCP of the main compartment 34.

The length LCI is generally less than 25% of the total length LT of the cabin, considered between the front end transverse wall 19 and the rear end transverse wall 22 and is in particular comprised between 15% and 25% of the total length LT of the cabin 12. The length LCI is generally greater than 2.54 m (greater than 100 inches) and in particular comprised between 2.54 m and 3.05 m (between 100 inches and 120 inches).

The intermediate compartment 32 comprises a clear central passageway 60 emerging across from the door 52 of the rear transverse wall 38, and, on either side of the central passageway 60, two isolation areas 62, 64.

Advantageously, the intermediate compartment 32 further comprises a cabinet 66.

The central passageway 60 has a minimum width, considered perpendicular to the aircraft axis A-A′, greater than 50.8 cm (greater than 20 inches). This width is also less than 61 cm (less than 24 inches).

Such a width allows the crew and passengers to access the rear compartment 30 and in particular the luggage storage area 44 by having enough space to move, and to bring luggage toward the space 44, without disturbing the passengers located in the isolation areas 62, 64.

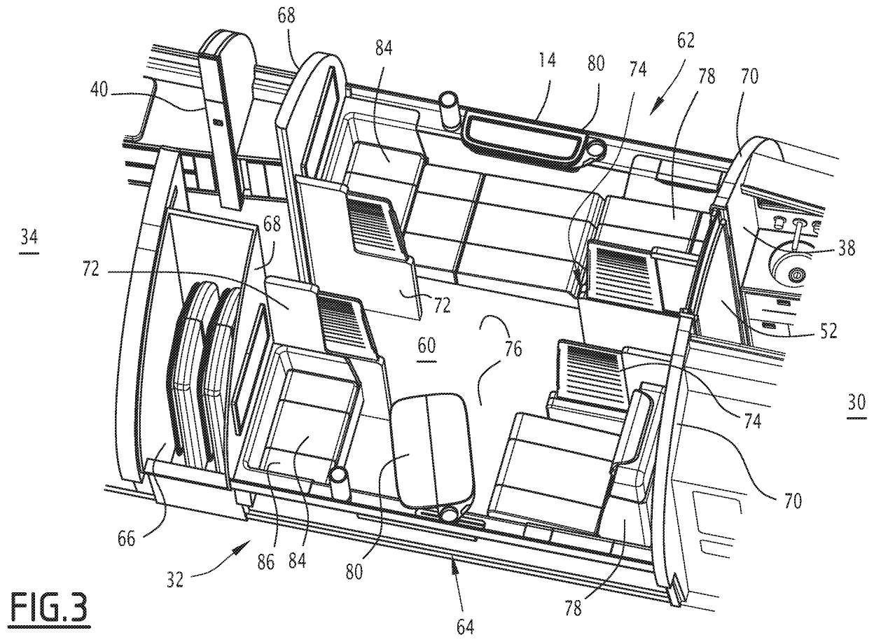

In reference to FIGS. 3 to 5, each isolation area 62, 64 is delimited in the front by a transverse partition 68, in the rear by a rear transverse partition 70 that here is formed by a region of the rear transverse wall 38.

The isolation area 62, 64 is further laterally delimited toward the central passageway 60 by at least one longitudinal partition 72, 74 delimiting an access opening 76 to the isolation area 62, 64. In this example, the isolation area 62, 64 is further laterally delimited toward the central passageway 60 by a front longitudinal partition 72 and a rear longitudinal partition 74 delimiting the access opening 76 between them.

Each isolation area 62, 64 further includes at least one seat 78, advantageously at least one table 80, a lateral storage compartment 82 and a footrest 84.

The front transverse partition 68 here extends over the entire height of the isolation area 62, 64, considered from the floor toward the inner trim of the fuselage 14. It is adjacent to the footrest 84 defining an upper bearing surface 86. It advantageously bears an electronic viewing equipment item 88, in particular a display monitor.

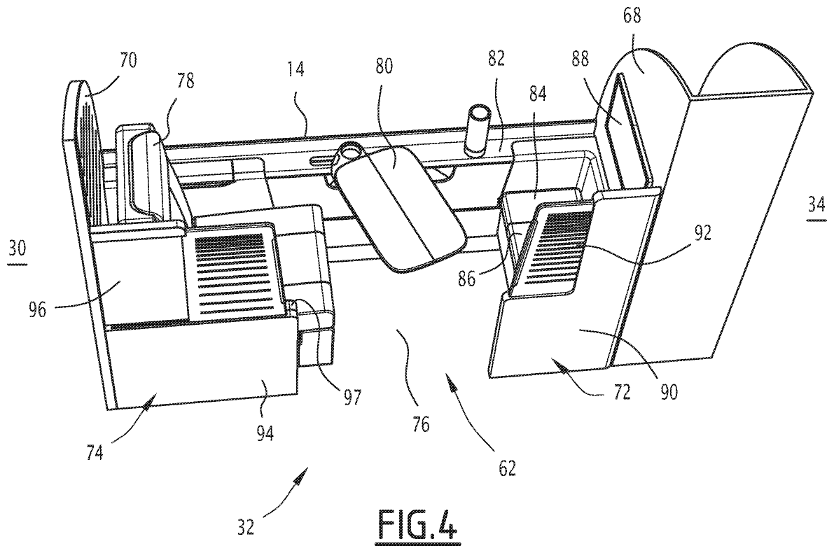

The front longitudinal partition 72 extends along the central passageway 60, in front of the access opening 76 to the isolation area 62, 64, adjacent to the front transverse partition 68. As visible in FIG. 4, in this example it has a lower part 90 that forms one side of the footrest 84 and an upper part 92 that protrudes upward from the lower part 90.

The rear longitudinal partition 74 has a lower part 94 that forms an armrest of the seat 78 and an upper part 96, which protrudes in a vertical plane parallel to a median vertical plane of the aircraft 10.

In this example, the upper part 96 of the partition 74 includes at least one longitudinal shutter, movable between a retracted rear position, clearing a front region 97 of the lower part (see FIG. 4), and a front isolating position located across from the front region 97 of the lower part 94.

The height of each longitudinal partition 72, 74 is greater than the maximum height of the seat 78 in its retracted seated position of a passenger, visible in FIG. 4.

The access opening 76 to the isolating area 62, 64 has a width greater than 50.8 cm (greater than 20 inches) to allow access to the inside of the isolating area 62, 64. Here it is clear at all times. It can be provided with a closing curtain when the passenger present in the isolating area 62, 64 wishes to isolate himself.

The maneuverable seat 78 has a width greater than 55.9 cm (greater than 22 inches), and in particular comprised between 55.9 cm and 61 cm (between 22 and 24 inches). It extends between two fixed armrests located on either side of the seat 78, one located along the fuselage 14, the other formed on the lower part 94 of the partition 74.

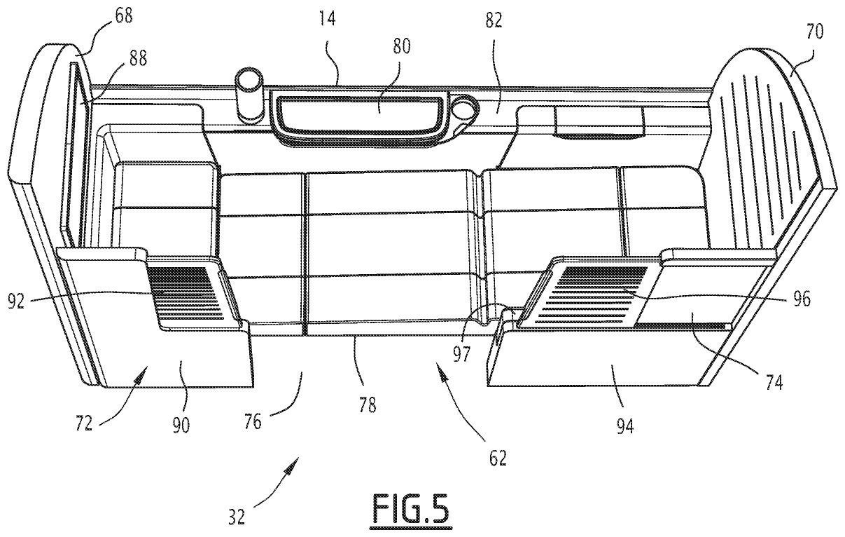

The seat 78 is maneuverable between a seated retracted position of the passenger, visible in FIG. 4, in which the seat bottom and the backrest of the seat 78 form an angle smaller than 120° and an extended deployed position, visible in FIG. 5, in which the upper surface of the seat bottom and the backrest form an angle equal to 180°. In its deployed position, the seat has an incline of 3° relative to the horizontal in order to offset the incline of the aircraft during the cruising phase.

In the seated position, the seat bottom of the seat 78 is located at a distance from the footrest 84. The space located between the seat bottom of the seat 78 and the footrest 84 emerges across from the access opening 76 in order to allow easier access to the seat 78.

In the deployed position, the seat bottom of the seat 78 is in contact with the footrest 84. The upper surfaces of the seat bottom, the backrest and the footrest 84 define a planar reclining surface, which has a length greater than 198 cm, in particular (greater than 78 inches), in particular comprised between 198 cm and 224 cm (between 78 inches and 88 inches).

The minimum width of this surface is also greater than 55.9 cm, and in particular comprised between 55.9 cm and 61 cm (between 22 inches and 24 inches).

Such a surface has the advantage of offering very comfortable reclining for a user of the seat 78, in the isolation zone 62, 64, without necessarily having to have an additional mattress on the seat 78 and without having to fill in an intermediate space between the footrest 84 and the seat 78 in the deployed position. This reclining is therefore very comfortable for the user.

Furthermore, the reclining of the user in the seat 78 does not hinder the possible movement of occupants of the aircraft between the intermediate compartment 32 and the rear compartment 30, since the width of the central passageway 60 is sufficient for this movement.

Each passenger present in an isolation area 62 of the intermediate compartment 32 can move toward the main compartment 34 or toward the rear compartment 30 without bothering another passenger potentially present in the other isolation area 64.

Likewise, a passenger present in the main compartment 34 is able to reach the rear compartment 30 without having to move the passenger(s) present in the isolation areas 62, 64. This arrangement is therefore particularly comfortable, despite the limited space present in a business jet.

The table 80, when it is present, is deployable transversely in the intermediate space between the seat 78 in the retracted position and the footrest 84.

The lateral storage compartment 82 is located along the fuselage 14, between the seat 78 and the fuselage 14. It offers a storage space for each passenger present in an isolation area 62, 64.

When it is present, the cabinet 66 is arranged between the front longitudinal partition 72 of an isolation area 62 and the intermediate transverse wall 40. It emerges laterally toward the central passageway 60.

In this example, the intermediate transverse wall 40 defines an intermediate passage opening 98 between the intermediate compartment 32 and the main compartment 34, which is laterally offset relative to the aircraft axis A-A′. Thus, the central passageway 60 has a bend in the front located between the front longitudinal partition of the isolation area 64 and the intermediate passage opening 98.

Conventionally, the main compartment 34 has a length LCP greater than the length LCI of the intermediate compartment 32 and the length LCA of the rear compartment 30.

The main compartment 34 is devoid of transverse separating wall between the intermediate transverse wall 40 and the front transverse wall 42.

It includes a plurality of passenger seats 100, advantageously tables 102 arranged between the passenger seats 100 and advantageously at least one lateral sofa 104. It includes at least one central aisle 106 between the seats.

In this example, the main compartment 34 includes, on either side of the central aisle 106, seats 100 facing one another each separated by a table 102. In another part of the cabin, it includes pairs of seats 100 arranged next to one another and facing another pair of seats 100, the two pairs of seats being separated by a table 102.

The central aisle 106 here has a first region 106A in the aircraft axis A-A′, and a second region 106B that is axially offset relative to the aircraft axis A-A′. In the second region 106B, a lateral sofa 104 is placed across from the pairs of seats 100. The second region 106B emerges in the intermediate passage opening 98.

The front transverse wall 42 is provided with a front passage opening 110. The front opening 110 here is located in the aircraft axis A-A′. It is for example closed off by a curtain.

The service and crew rest compartment 36 includes a pantry 112 allowing the preparation of food and beverages for the occupants of the aircraft, a lavatory 114 and a crew rest space 116 allowing a pilot of the aircraft to sit down and/or stretch out to rest. It further includes a side door 118 for entry into the aircraft 10.

In the example shown in the figures, the aircraft 10 is devoid of side access door 118 into the main compartment 30, into the intermediate compartment 32, or into the rear compartment 34.

During use, each occupant of the aircraft 10 is free to move around in the main compartment 34 and to enter the rear compartment 30 by passing through the intermediate compartment 32.

To that end, the occupant passes through the intermediate passage opening 98, and moves through the central passageway 60 with enough space to carry any luggage, without interacting with the isolation areas 62, 64 and with any occupants of these isolation areas 62, 64.

The occupant can thus reach the rear door 52, open it and enter the rear compartment 30, either to use the lavatory 46, or to drop off or recover luggage in the luggage storage area 44.

At least two passengers of the aircraft are able to rest in the isolation areas 62, 64, without interaction with the other occupants.

To that end, they can reach the intermediate compartment 32 from the main compartment 34 through the central passageway 60 and enter an isolation area 62, 64 through the access opening 76. In the isolation area 62, 64, they can keep the seat 78 in the retracted position, to sit on the seat. When they wish to lie down, they can deploy the seat 78 in order to create a reclining surface in the isolation area 62, 64 and stretch out, while being laterally protected toward the aircraft axis A-A′ by each longitudinal partition 72, 74.

The intermediate compartment 32 therefore constitutes, in the limited space of a business jet, a very comfortable and isolated personal isolation area. The isolation areas 62, 64 thus defined in the intermediate compartment 32 offer a very extensive horizontal reclining surface, without the need for additional equipment.

Unlike the business jets of the state of the art, the presence of passengers in the intermediate compartment 32 does not hinder the use of the rear compartment 30, in particular the lavatory 46 or the luggage storage space 44, both for each occupant present in the intermediate compartment 32, and for the occupants present in the main compartment 34.

The transition to the reclining position is further very simple to perform, and does not require the intervention of the commercial personnel present in the aircraft 10.

What is claimed is:

1. An aircraft cabin extending into a fuselage along an aircraft axis, the aircraft cabin comprising:
a front end transverse wall configured to be adjacent to a cockpit of the aircraft;
a rear end transverse wall configured to be adjacent to a rear technical hold of the aircraft, the cabin delimiting an inner volume accessible to a passenger of the aircraft, the cabin comprising, in the inner volume:
a rear compartment, delimited by the rear end transverse wall and including at least one luggage storage area and/or a lavatory,
a main compartment including a plurality of seats, and
an intermediate compartment having a rear adjacent to the rear compartment and having a front adjacent to the main compartment;
a rear transverse wall provided with a door, the rear transverse wall delimiting a front of the rear compartment;
an intermediate transverse wall delimiting a circulation opening between the intermediate compartment and the main compartment, the intermediate transverse wall delimiting a rear of the main compartment, the intermediate compartment extending between the rear transverse wall and the intermediate transverse wall,
the intermediate compartment comprising, on either side of the fuselage, isolation areas, and between the isolation areas, a central passageway, the central passageway having a width greater than 50.8 cm, each isolation area including a seat and at least one longitudinal partition separating the isolation area from the central passageway, the at least one longitudinal partition delimiting an access opening to the isolation area, each seat located in each isolation area being maneuverable between a retracted seating position for an occupant of the isolation area and an extended lying position of an occupant of the isolation area.

2. The cabin according to claim 1, wherein the central passageway has a width smaller than 61 cm, taken transversally between the respective at least one longitudinal partition of the respective isolation areas.

3. The cabin according to claim 1, wherein the door of the rear transverse wall opens opposite the central passageway.

4. The cabin according to claim 3, wherein the width of the door of the rear transverse wall is less than 110% of the width of the central passageway.

5. The cabin according to claim 1, wherein in the extended position, each seat in each isolation area delimits a horizontal lying surface for the occupant, having a length greater than 198 cm.

6. The cabin according to claim 5, wherein in the extended position, each seat in each isolation area delimits a horizontal lying surface for the occupant, having a width greater than 55.9 cm.

7. The cabin according to claim 1, wherein each isolation area includes a front longitudinal partition and a rear longitudinal partition delimiting between them the access opening to the isolation area.

8. The cabin according to claim 7, wherein at least one of the front lateral partition or of the rear lateral partition is longitudinally movable relative to the seat located in the isolation area.

9. The cabin according to claim 1, wherein the intermediate compartment includes at least one curtain able to close off the access opening to the isolation area.

10. The cabin according to claim 1, wherein each isolation area includes at least one table, deployable opposite the seat located in the isolation area.

11. The cabin according to claim 1, wherein the intermediate compartment includes at least one cabinet located at a front of or at a rear of one of the isolation areas.

12. The cabin according to claim 1, including a total number of seats less than twenty-five between the front end transverse wall configured to be adjacent to the cockpit of the aircraft and the rear end transverse wall, configured to be adjacent to the rear technical hold of the aircraft.

13. The cabin according to claim 1, wherein the rear compartment comprises a rear passageway, extending along the aircraft axis, with a width greater than 50.8 cm.

14. A business jet comprising:
a cockpit, and
the aircraft cabin according to claim 1, a front of the aircraft cabin opening in the cockpit.

15. The business jet according to claim 14, having a maximum takeoff weight of less than 55,000 kg.

16. The business jet according to claim 14, including, at a rear of the rear compartment, a technical hold adjacent to the rear compartment, the technical hold defining a rear end of the aircraft.
